(19) United States
(12) Patent Application Publication
(10) Pub. No.: US 2011/0037790 A1
(43) Pub. Date: Feb. 17, 2011

(54) BACKLIGHT APPARATUS AND IMAGE DISPLAY APPARATUS USING THE SAME

(75) Inventor: Toshiki Onishi, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/988,151

(22) PCT Filed: Feb. 8, 2010
(86) PCT No.: PCT/JP2010/000723

§ 371 Date: Oct. 15, 2010

(30) Foreign Application Priority Data
Feb. 26, 2009 (JP) 2009-044586

(51) Int. Cl. G09G 5/10

(52) U.S. Cl. 345/690

(57) ABSTRACT

A backlight apparatus that can perform local contrast control is provided. LED backlight 121 has a light emitting surface that includes P light emitting areas which individually emit illumination light and which are divided into Q groups, and radiates illumination light from the P light emitting areas, onto liquid crystal panel 110. Feature amount detecting section 131 detects the feature amount of an image signal. Brightness calculating section 132 determines light emission brightness values of the P light emitting area, based on the detected feature amount per light emitting area. Backlight driving section 122 renews light emitting states in the P light emitting areas, per group based on the determined light emission brightness values while driving the P light emitting areas. Further, backlight driving section 122 switches a group to renew a light emitting state among the Q groups, every N frame of an image signal.

### TECHNICAL FIELD

The present invention relates to a backlight apparatus and an image display apparatus using this backlight apparatus.

### BACKGROUND ART

As a type of a liquid crystal display apparatus as an image display apparatus, there is a liquid crystal display apparatus that illuminates a liquid crystal panel using an LED backlight formed by arraying light emitting diodes (LED's).

Particularly, a technique referred to as “local contrast control” is known (see Patent Literature 1 and Patent Literature 2). This technique improves contrast of a display image by two-dimensionally arraying LEDs directly below a liquid crystal panel and controlling the brightness of LEDs according to a brightness setting value (hereinafter also simply referred to as “brightness value”) of an image signal.

FIG. 1 is a block diagram showing a configuration of a liquid crystal display apparatus disclosed in Patent Literature 1. Liquid crystal display apparatus 10 shown in FIG. 1 is formed with liquid crystal display panel 11 and backlight unit 12. Backlight unit 12 is segmented into a plurality of subunits 13 (two subunits 13A and 13B are shown in FIG. 1) that can individually adjust brightness in the surface facing liquid crystal display panel 11. The liquid crystal display section of liquid crystal display panel 11 is segmented into pixel blocks 14 (two pixel blocks 14A and 14B are shown in FIG. 1) of each surface facing each subunit. Liquid crystal display apparatus 10 has first means 15 and second means 16. First means 15 calculates the maximum brightness from display data inputted in each pixel in pixel blocks 14. Second means 16 adjusts the brightness of facing subunits 13 according to the magnitude of the maximum brightness calculated in first means 15. On the other hand, in each subunit 13, the brightness value is renewed in synchronization with a vertical synchronization signal (“Vsync”).

FIG. 2 is a block diagram showing a configuration of a liquid crystal display apparatus disclosed in Patent Literature 2. In liquid crystal display apparatus 20 shown in FIG. 2, the backlight has a plurality of light emitting areas 21A to 21D that can control light emission brightness using backlight brightness adjusting sections 22A to 22D. The light emission brightness of light emitting areas 21A to 21D is set according to the maximum display brightness of their corresponding display areas of liquid crystal panel 23, and the transmittance of pixels of liquid crystal panel 23 is set according to the light emission brightness value of each light emitting area 21A to 21D. On the other hand, in light emitting areas 21A to 21D, brightness values are renewed in synchronization with scanning of an image signal.

### Citation List

### Patent Literature

PTL 1: Japanese Patent Application Laid-Open No. 2004-191490
PTL 2: Japanese Patent Application Laid-Open No. 2008-71603

### SUMMARY OF INVENTION

### Technical Problem

Generally, in case where a display surface of a liquid crystal panel is sectionalized into a plurality of display areas and the brightness in the positions of the backlight corresponding to the respective display areas is controlled, the following memories are required. The first one is a memory that stores the feature amount of an image signal in each display area. The second one is a memory that stores a backlight brightness setting value of a light emitting area corresponding to each display area, which is determined based on the feature amount of the stored image signal. Accordingly, when the number of display areas is greater, greater memory capacity is required. Further, when the number of display areas is greater, the load to calculate the brightness setting value of the backlight (also including the load to detect the feature amount of an image signal, depending on cases) from the feature amount of the image signal, increases. Furthermore, when the number of display areas becomes greater, the load to transmit these brightness setting values to a drive circuit becomes greater, and the number of transmission lines increases.

Generally, LED drive ICs are classified as follows in terms of the brightness value setting of each channel. First, regarding the functions of individual ICs, LED drive ICs are classified into (1) LED drive ICs which can set the brightness value of one desired channel according to a command for one channel, and (2) LED drive ICs which collectively set brightness values of all channels by receiving commands for all channels. Further, regarding a case where a plurality of identical ICs are used, LED drive ICs are classified into (3) LED drive ICs that allow selection of ICs in which brightness values need to be set, and (4) LED drive ICs which are not renewed unless the above ICs are connected in daisy-chain and receive commands for all channels of all ICs.

Here, when the number of display areas increases, problems that arise include the above calculation load and transmission load. To reduce these loads, the brightness value of each frame is generally renewed every G frame (where G is a natural number equal to or more than two). However, this causes delay in optimization of brightness in the entire screen (that is, optimization of contrast). Moreover, in a frame in which renewal is performed, the renewal load is still high. Therefore, after a feature amount of an image signal for one screen is detected in one frame and brightness setting values for all display areas are calculated, it is necessary to transmit control signals based on these brightness setting values to a drive IC to prevent delay as much as possible. For example, with the renewal method disclosed in Patent Literature 1, the brightness value of each subunit 13 is simply renewed in synchronization with a vertical synchronization signal (“Vsync”), and therefore there is the above-described problem.

By contrast with this, with, for example, the renewal method disclosed in Patent Literature 2, the brightness value of each light emitting area 21A to 21D is renewed in synchronization with scanning of an image signal, and therefore there is more allowance than the method disclosed in Patent Literature 1. However, in case where a drive IC having the specification of above (4) used, the condition of transmission is more severe than the method disclosed in Patent Literature 1. This is because, in case where the display screen of liquid crystal panel 23 is sectionalized into H (where H is a natural number) in the vertical direction and renewal is performed H times in one frame in synchronization with scanning of an image signal, data for all light emitting areas needs to be transmitted H times in one frame. Further, in case where a drive IC having the specification of above (2) is used, the condition of transmission is more severe than the method disclosed in Patent Literature 1. In order to deal with this problem, although it is possible to, for example, transmit data in parallel from a transmitter, there is a problem that the number of wirings and a circuit scale increase. Further, even if the transmission frequency is simply increased, there is a possibility that a transmission error occurs due to a problem such as clock skew, and, in addition, EMI (Electromagnetic Interference) increases due to unnecessary radiation. Furthermore, there are problems in the standards such as SPI (System Packet Interface), I2C (Inter-Integrated Circuit), and RSDS (Reduced Swing Differential Signaling), and allowable received frequencies of ICs.

Accordingly, a liquid crystal apparatus (particularly, a backlight apparatus) is demanded that can perform local contrast control with little memory capacity, calculation load and transmission load (including the problems of the number of wirings and unnecessary radiation) in case where the brightness in the positions of the backlight corresponding to the respective display areas of the display surface is controlled.

It is therefore an object of the present invention to provide a backlight apparatus that can perform quality local contrast control while reducing a transmission load.

### Solution to Problem

The backlight apparatus according to the present invention includes: a light emitting section that has P light emitting areas which individually emit illumination light and which are divided into Q groups, where P is an integer equal to or more than two and Q is an integer equal to or more than two and equal to or less than P, and that radiates the illumination light from the P light emitting areas onto a light modulating section; a feature amount detecting section that detects a feature amount of an image signal; a determining section that determines light emission brightness values of the P light emitting areas, per light emitting area, based on the detected feature amount; and a driving section that renews light emitting states in the P light emitting areas per group, based on the determined light emission brightness values, while driving the P light emitting areas, wherein the driving section switches a group to renew a light emitting state among the Q groups, every N frame of the image signal, where N is a natural number.

### Advantageous Effects of Invention

According to the present invention, it is possible to perform quality local contrast control while reducing a transmission load.

### BRIEF DESCRIPTION OF DRAWINGS

FIG. 1 is a block diagram showing an example of a configuration of a conventional liquid crystal display apparatus:

FIG. 2 is a block diagram showing another example of a conventional liquid crystal display apparatus;

FIG. 3 is a block diagram showing a schematic configuration of an image display apparatus using a backlight apparatus according to Embodiment 1 of the present invention;

FIG. 4 is a schematic diagram showing a main part configuration of an LED backlight of FIG. 3;

FIG. 5 illustrates a preferable example of grouping of light emitting areas according to Embodiment 1 of the present invention, where FIG. 5A is a schematic diagram showing an unpreferable example and FIG. 5B is a schematic diagram showing a preferable example;

FIG. 6 is a schematic diagram showing an example of a preferable variation of grouping of light emitting areas according to Embodiment 1 of the present invention, where FIG. 6A shows formation of a checkered pattern, FIG. 6B shows formation of a vertical stripe pattern, FIG. 6C is formation of a diagonal pattern and FIG. 6D shows formation of a concentric pattern;

FIG. 7 illustrates an example of a renewal method of brightness setting according to Embodiment 1 of the present invention, where FIG. 7A is a schematic diagram showing an example of a conventional renewal method and FIG. 7B shows an example of a renewal method according to the present embodiment;

FIG. 8 illustrates another example of a renewal method of brightness setting according to Embodiment 1 of the present invention, where FIG. 8A is a schematic diagram showing another example of a conventional renewal method and FIG. 8B is a schematic diagram showing another example of a renewal method according to the present embodiment;

FIG. 9 illustrates another example of a renewal method of brightness setting according to Embodiment 1 of the present invention, where FIG. 9A is a schematic diagram showing an example of another possible renewal method and FIG. 9B is a schematic diagram showing another example of a renewal method according to the present embodiment;

FIG. 10 is a block diagram showing a modified example of a schematic configuration of an image display apparatus that uses a backlight apparatus according to Embodiment 1 of the present invention; and

FIG. 11 is a block diagram showing another modified example of a schematic configuration of an image display apparatus that uses a backlight apparatus according to Embodiment 1 of the present invention.

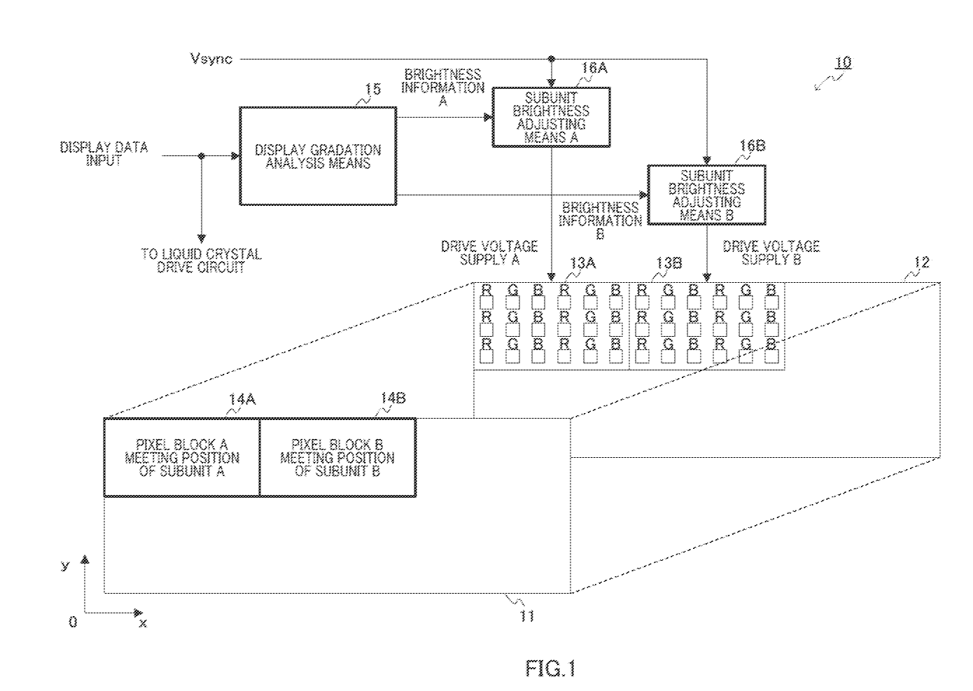

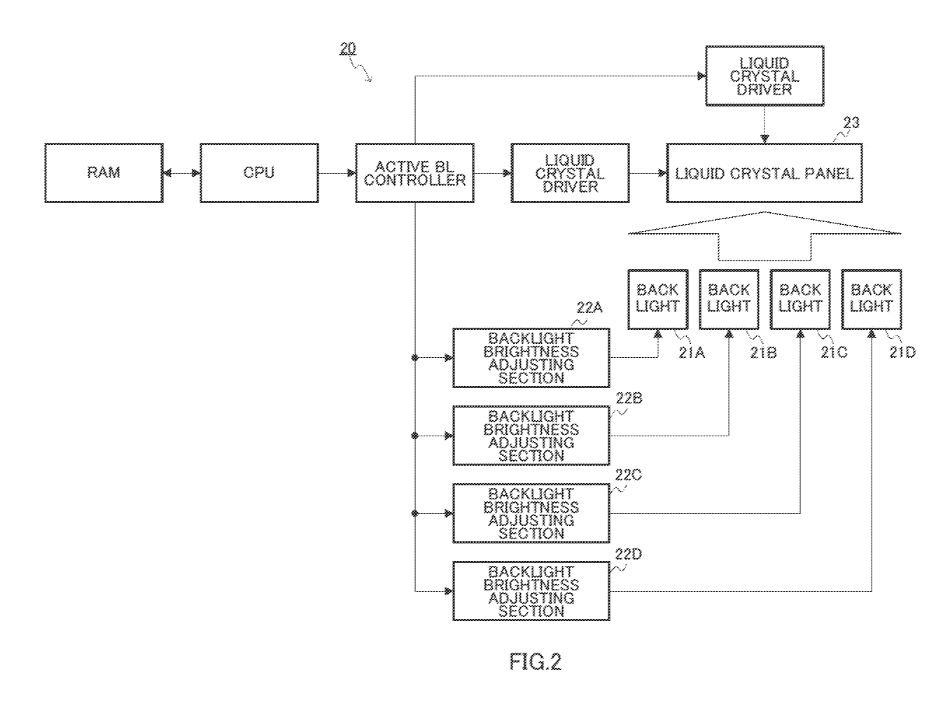

### DESCRIPTION OF EMBODIMENTS

Hereinafter, an embodiment of the present invention will be explained in detail with reference to the accompanying drawings. Note that, with the present embodiment and its modified example, the same or corresponding components will be assigned the same reference numerals to avoid overlapping detailed explanation.

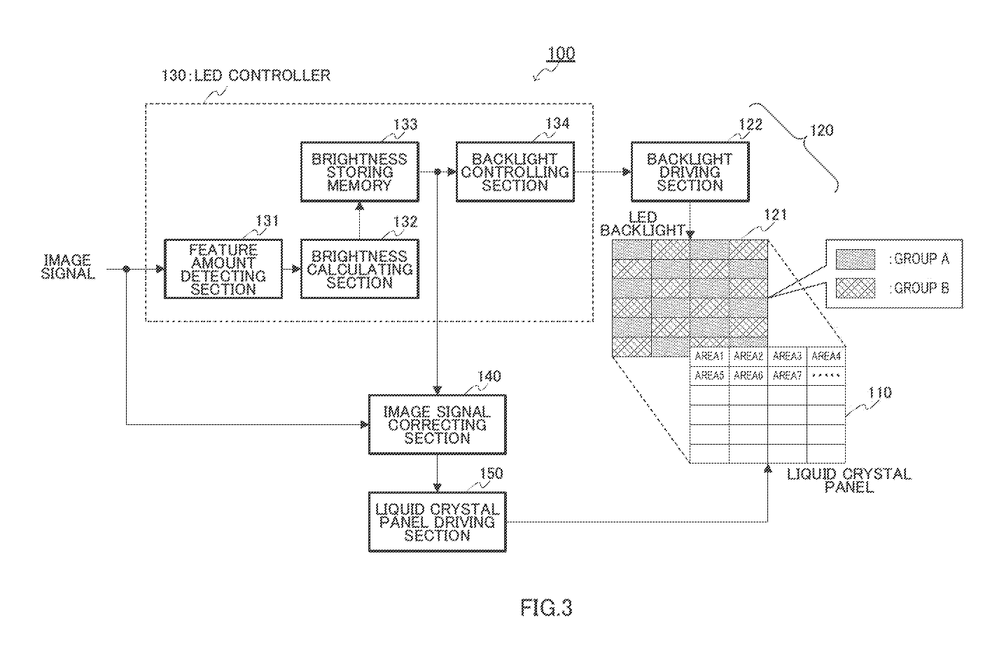

FIG. 3 is a block diagram showing a schematic configuration of an image display apparatus that uses a backlight apparatus according to Embodiment 1 of the present invention.

Image display apparatus 100 shown in FIG. 3 expands the dynamic range of a display image and increases contrast of the display image by controlling brightness of a backlight light source that radiates illumination light onto the back surface of liquid crystal panel 110, according to an image signal. Further, image display apparatus 100 can save power of the apparatus. Roughly, this image display apparatus 100 has liquid crystal panel 110, illuminating section 120, LED controller 130, image signal correcting section 140, and liquid crystal panel driving section 150. Illuminating section 120 has LED backlight panel 121 (hereinafter simply “LED backlight”) and backlight driving section 122. Further, LED controller 130 has feature amount detecting section 131, brightness calculating section 132, brightness storing memory 133 and backlight controlling section 134. Note that the backlight apparatus is formed with illuminating section 120 and LED controller 130.

Liquid crystal panel 110 as a light modulating section has a function of creating an image based on an image signal, on a display surface by optically modulating illumination light radiated onto the back surface of liquid crystal panel 110 according to the image signal. Liquid crystal panel 110 is, for example, a common liquid crystal panel, and is formed with a polarizing plate, liquid crystal cell and color filter (not shown). The display surface of liquid crystal panel 110 is sectionalized into a plurality of display areas (i.e. sectional areas) as shown in FIG. 3. Note that the light modulating section is formed with liquid crystal panel 110 with the present embodiment, and therefore image display apparatus 100 will be referred to as “liquid crystal display apparatus 100” in the following explanation.

Illuminating section 120 radiates illumination light for displaying an image on liquid crystal panel 110, onto the back surface of liquid crystal panel 110. Illuminating section 120 has LED backlight 121 and backlight driving section 122 as described above.

LED backlight 121 as a light emitting section is arranged to face the back surface of liquid crystal panel 110, and radiates illumination light onto the back surface of liquid crystal panel 110. LED backlight 121 has a plurality of light emitting areas for illuminating a plurality of display areas of liquid crystal panel 110, and is configured to set light emission brightness per light emitting area. Each light emitting area is arranged to face a corresponding display area of liquid crystal panel 110, and mainly radiates the facing display area. Here, the word “mainly” suggests that each light emitting area may radiate part of its illuminating light on other image display areas that the light emitting area does not face. Each light emitting area has LEDs 123 as light sources.

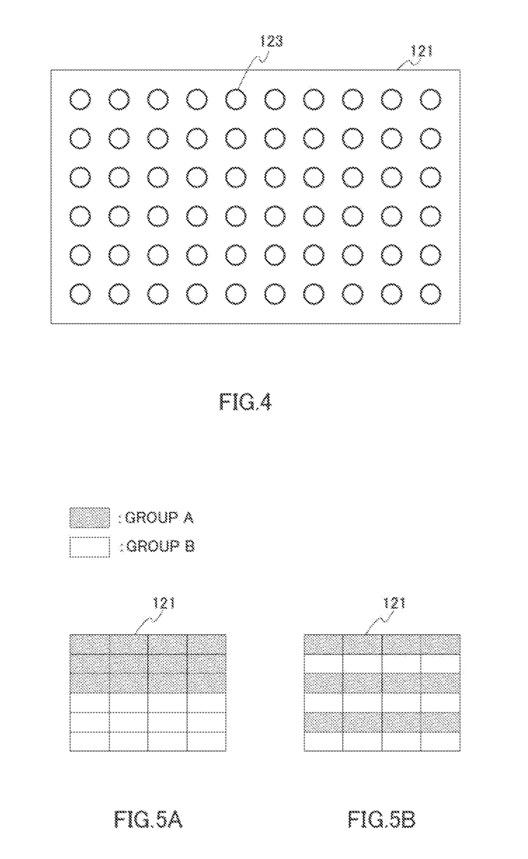

FIG. 4 is a schematic diagram showing a main part configuration of LED backlight 121, where a specific example of array of LEDs 123 in LED backlight 121 is shown.

LED backlight 121 has multiple (here, 6×10=60 as an example for ease of explanation) LEDs (for example, white LEDs) 123 as shown in FIG. 4. LED backlight 121 is a direct type backlight panel in which these multiple LEDs 123 are arrayed in virtually a planar shape on a substrate, being oriented toward the back surface of liquid crystal panel 110.

Backlight driving section 122 as a driving section drives LED backlight 121. To be more specific, backlight driving section 122 can drive LEDs 123 individually or in units of a plurality of LEDs 123 of LED backlight 121, thereby making it possible to adjust the brightness of each light emitting area of LED backlight 121. For example, backlight driving section 122 uses one or a plurality of LED drive ICs such that the total number of channels is equal to or greater than the number of light emitting areas of LED backlight 121. Then, backlight driving section 122 employs a configuration (not shown) in which individual channels of LED ICs correspond to individual light emitting areas of LED backlight 121 (that is, also correspond to display areas of liquid crystal panel 110) on a one-on-one basis. With this configuration, corresponding channels of the LED drive ICs can individually control the brightness of light emitting areas. That is, there are LED drive ICs in which the number of outputs is one channel (i.e. one-channel output type) and LED drive ICs in which the number of outputs is multiple channels (i.e. multi-channel output type). In either type, individual channels are connected to LEDs 123 that belong to corresponding light emitting areas of LED backlight 121. By this means, backlight driving section 122 controls brightness of the light sources (i.e. LEDs 123) per light emitting area of LED backlight 121. In this case, all LEDs 123 belonging to one light emitting area emit light at the same brightness, according to signals from corresponding channels of LED drive ICs.

Note that, if an IC is required per light emitting area, its LED drive IC is the one-channel output type, and, if a smaller number of ICs than the number of light emitting areas is required, those LED drive ICs are the multi-channel output type. Practically speaking, the number of light emitting areas of LED backlight 121 (equivalent to the number of sections of the display surface of liquid crystal panel 110) is great (for example, 64 to 1000), and therefore the one-channel output type has difficulty in supporting this. Hence, a configuration is generally employed where one or a plurality of multi-channel output type LED drive ICs are used. In this case, the total number of channels of one or a plurality of LED drive IC channels is equal to or more than the number of light emitting areas such that each light emitting area can be driven individually.

With the above configuration, illuminating section 120 can control brightness per light emitting area. In illuminating section 120, LED backlight 121 is arranged on the back surface side of liquid crystal panel 110 to illuminate liquid crystal panel 110 by white light (i.e. illumination light) emitted from LEDs 123 in which brightness is controlled per light emitting area.

Note that the light sources of LED backlight 121 are not limited to LEDs 123, and may be the light sources arranged such that brightness can be adjusted per light emitting area. For example, the light sources of LED backlight 121 may emit white light by blending red, green and blue lights.

LED controller 130 has the function of calculating a light emission brightness value (i.e. brightness setting value) per light emitting area of LED backlight 121 from an input image signal, and outputting the light emission brightness value to backlight driving section 122. LED controller 130 has feature amount detecting section 131, brightness calculating section 132, brightness storing memory 133 and backlight controlling section 134 as described above.

Feature amount detecting section 131 detects the feature amount of an input image signal. To be more specific, feature amount detecting section 131 detects the feature amount of an input image signal per display area of liquid crystal panel 110. Here, “feature amount” refers to the feature amount related to the brightness of an image signal of each display area in liquid crystal panel 110. For the feature amount, it is possible to use, for example, the maximum brightness level, minimum brightness level, the difference between the maximum brightness level and the minimum brightness level or the average brightness of an image signal of each display area in liquid crystal panel 110. The detected feature amount is outputted to brightness calculating section 132. Note that image signals are inputted not only to feature amount detecting section 131 but also to image signal correcting section 140.

Brightness calculating section 132 as a determining section determines a light emission brightness value of each light emitting area by calculating the light emission brightness value (in other words, brightness setting value) of a light emitting area of LED backlight 121 corresponding to each display area, based on the detection result in feature amount detecting section 131 (i.e. the feature amount of an image signal of each display area of liquid crystal panel 110). To be more specific, for example, brightness calculating section 132 calculates a light emission brightness value (that is, brightness setting value) indicating the brightness at which a light emitting area corresponding to each display area must emit light, from the feature amount of each detected display area using the conversion table or conversion function having predetermined characteristics. The calculated light emission brightness value is outputted to brightness storing memory 133.

Brightness storing memory 133 temporarily stores the calculation result of brightness calculating section 132 (i.e. the light emission brightness value of the light emitting area of LED backlight 121 corresponding to each display area of liquid crystal panel 110). Brightness storing memory 133 is formed with, for example, a register. The light emission brightness values stored in brightness storing memory 133 are outputted to backlight controlling section 134 and image signal correcting section 140.

Backlight controlling section 134 reads from brightness storing memory 133 the light emission brightness value of the light emitting area corresponding to each display area, and generates the control signal for backlight driving section 122. The generated control signal is outputted to backlight driving section 122.

Note that backlight driving section 122 drives LED backlight 121 as described above, based on the control signal from backlight controlling section 134. As described above, this control signal is generated based on the light emission brightness value calculated in brightness calculating section 132. Thus, when LED backlight 121 is driven based on this control signal, each light emitting area emits light according to the light emission brightness value based on the feature amount of an image signal. That is, the light emitting state of each light emitting area of LED backlight 121 is renewed by driving LED backlight 121 (i.e. renewal brightness setting) using the control signal based on the light emission brightness value which is a brightness setting value.

Image signal correcting section 140 corrects an image signal inputted to liquid crystal panel 110, based on the light emission brightness value calculated in LED controller 130. To be more specific, image signal correcting section 140 reads the light emission brightness value of each light emitting area of LED backlight 121, from brightness storing memory 133, and corrects the image signal inputted to liquid crystal panel 110 based on the read light emission brightness value. The image signal inputted to liquid crystal panel 110 in this way is optimized according to the light emission brightness value of the light emitting area of LED backlight 121 corresponding to each display area. The corrected image signal is outputted to liquid crystal panel driving section 150. Note that information used for correction may be, for example, a signal (that is, the feature amount) from feature amount detecting section 131 instead of data from brightness storing memory 133.

Liquid crystal panel driving section 150 drives liquid crystal panel 110 based on the image signal corrected by image signal correcting section 140.

Note that image signals may be inputted to liquid crystal panel driving section 150 without correction. However, as described above, by optimizing an image signal inputted to liquid crystal panel 110 taking into account light emission brightness of LED backlight 121 that illuminates the back surface of liquid crystal panel 110, it is possible to display an image having more contrast and gradation. By contrast with this, it is equally possible to determine the brightness setting value of LED backlight 121 taking this correction into account.

Next, the LED controlling method of LED backlight 121 in liquid crystal display apparatus 100 employing the above configuration will be explained.

In case where multiple LEDs 123 are arranged as light sources of LED backlight 121, the number of LEDs 123 is preferably set to a number that can be divided by the number of sections P (where P is an integer equal to or more than two) of the display surface. In this case, the number of LEDs 123 inside the light emitting area corresponding to each display area becomes equal, and LEDs 123 inside each light emitting area are driven at the same brightness per light emitting area.

General LED drive ICs used to drive LEDs each generally have a multi-channel current source, and can drive connection loads (here, LED 123) using a varying current value. The LEDs are connected and driven such that LEDs for one light emitting area are connected with one channel. However, a scheme of making the current values of all ICs equal, performing PWM (Pulse Width Modulation) drive per each channel and changing the brightness value per channel is more popular. This brightness value is generally set by receiving digital data from a controlling section (here, LED controller 130) according to a transmission scheme such as the above SPI or I2C or RDSD.

As described above, LED drive ICs are generally classified as follows in terms of the brightness value setting of each channel. First, regarding the functions of individual ICs, LED drive ICs are classified into (1) LED drive ICs which can set the brightness value of one desired channel according to a command for one channel, and (2) LED drive ICs which collectively set brightness values of all channels by receiving commands for all channels. Further, regarding a case where a plurality of identical ICs are used, LED drive ICs are classified into (3) LED drive ICs that allow selection of ICs in which brightness values need to be set, and (4) LED drive ICs which are not renewed unless the above ICs are connected in daisy-chain and receive commands for all channels of all ICs.

Here, when the number of display areas becomes greater, in addition to the memory capacity, problems that arise include the calculation load and transmission load as described above. With the example of FIG. 3, the calculation load is the calculation load of brightness calculating section 132 (including the calculation load of feature amount detecting section 131 depending on cases), and the transmission load is the transmission load of digital data from backlight controlling section 134 to backlight driving section 122. The techniques disclosed in Patent Literature 1 and Patent Literature 2 are not essentially directed to reducing these loads. However, even if the renewal method disclosed in Patent Literature 1 and the renewal method disclosed in Patent Literature 2 are used as the method of reducing these loads, there is a certain limitation in these renewal methods as described above.

Hence, with the present invention, a plurality of light emitting areas are divided into a plurality of groups to reduce memory capacity, calculation load and transmission load. Then, the present invention employs a configuration of switching, once every N frame of an image signal (where N is a natural number), a group to renew setting of light emission brightness (hereinafter also simply referred to as “brightness setting”), in other words, a group to renew the light emitting state. Note that, as described above, each display area of liquid crystal panel 110 and each light emitting area of LED backlight 121 correspond to each other on a one-on-one basis and the numbers of them are the same, and therefore grouping of light emitting areas is equivalent to grouping of display areas. Hereinafter, explanation will be made mainly using light emitting area as the grouping target.

To be more specific, with the present embodiment, P light emitting areas are grouped into Q groups each formed with virtually an equal number of light emitting areas (where Q is an integer equal to or more than two and equal to or less than P). Preferably, the number of belonging light emitting areas is the same between the Q groups. Further, every N frame (for example, one frame), a group to validate renewal of brightness setting is switched.

Hereinafter, arrangement of groups will be explained first. Note that, for ease of explanation, a case will be explained as an example where twenty four light emitting areas of six rows and four columns are divided into two groups (group A and group B) having the same number of belonging light emitting areas, and the groups are switched per frame.

FIG. 5 illustrates an example of grouping of light emitting areas according to the present embodiment, where FIG. 5A is a schematic diagram showing an unpreferable example and FIG. 5B is a schematic diagram showing a preferable example.

First, as shown in FIG. 5A, on a light emitting surface formed with all light emitting areas, such grouping is not preferable where light emitting areas of each group get together per group (that is, crowd in one portion) disproportionately (that is, light emitting areas concentrate in a specific location and lack overall balance). As shown in FIG. 5B, grouping is preferable where light emitting areas of each group are distributed virtually evenly (i.e. uniformly) over the entire light emitting surface. To be more specific, when, for example, the origin is set in the center of the display surface of liquid crystal panel 110, grouping is performed by selecting light emitting areas such that the median point of each group concentrates near this origin. Thus, in case where, for example, the IC of above (1) or the IC combining above (2) and (3) is used, Q groups only need to be renewed once every Q frame, and therefore the renewal load per frame is one-Qth. Further, groups are distributed virtually uniformly in the entire light emitting surface, so that it is possible to renew brightness smoothly with less visual unnaturalness.

On the other hand, in case where switching needs to be performed with allowance, the group to validate renewal of brightness setting may be switched every multiple frame. Further, brightness may be renewed intermittently every multiple frame. For example, in case of still images or signals of images showing little motion, this renewal method is effective to reduce the load upon renewal of brightness setting while enjoying the benefit of local contrast control.

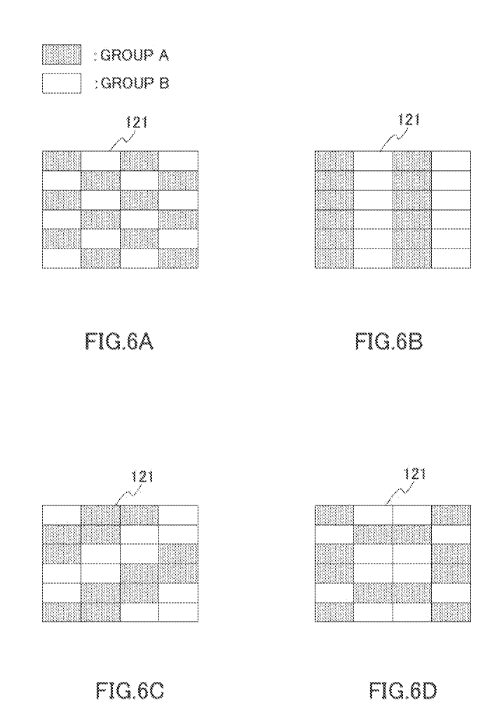

FIG. 6 is a schematic diagram showing an example of a preferable variation of grouping of light emitting areas according to the present embodiment, where FIG. 6A shows formation of a checkered pattern, FIG. 6B shows formation of a vertical stripe pattern, FIG. 6C shows formation of a diagonal stripe pattern and FIG. 6D shows formation of a concentric pattern.

That is, with the example shown in FIG. 6A, the light emitting areas belonging to two groups A and B are arranged in a checkered pattern (i.e. a pattern of arranging squares of two colors alternately). With the example shown in FIG. 6B, the light emitting areas belonging to two groups A and B are arranged in a vertical stripe pattern. With the example shown in FIG. 6C, the light emitting areas belonging to two groups A and B are arranged in a diagonal stripe pattern. With the example shown in FIG. 6D, the light emitting areas belonging to two groups A and B are arranged in a concentric pattern. By the way, the example shown in FIG. 5B shows a case where the light emitting areas belonging to two groups A and B are arranged in a horizontal stripe pattern. With these examples, in case where, for example, groups are switched per frame, the brightness setting of the light emitting areas belonging to group A and the light emitting areas belonging to group B is renewed in an odd-numbered frame and an even-numbered frame, respectively. Note that which grouping method to select may be determined taking into account, for example, control of LED drive ICs and convenience of wirings of a substrate on which LEDs are mounted.

Next, the group renewal method (i.e. timing) will be explained. Note that a case will be explained here as an example where grouping is performed in a checkered pattern as shown in FIG. 6A.

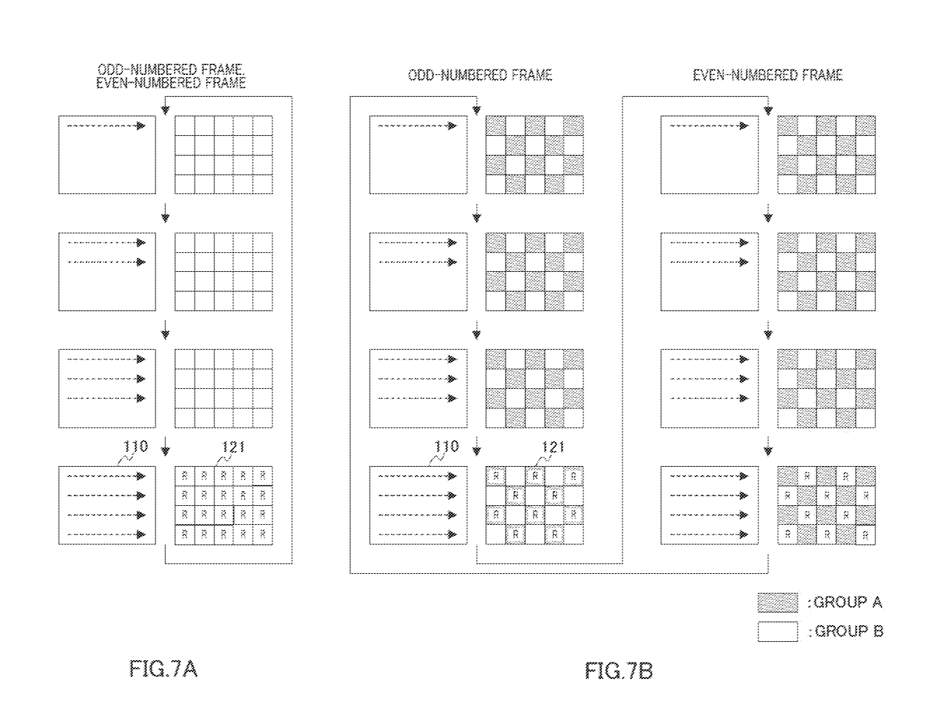

FIG. 7 illustrates an example of a method of renewal brightness setting according to the present embodiment, where FIG. 7A is a schematic diagram showing an example of a conventional renewal method and FIG. 7B is a schematic diagram showing an example of a renewal method according to the present embodiment.

To be more specific, FIG. 7A shows a conventional renewal method of renewal brightness setting in synchronization with a vertical synchronization signal (“Vsync”). The left part of this figure shows how an image signal is scanned in liquid crystal panel 110, and the right part of this figure shows how brightness setting is renewed in LED backlight 121. The light emitting areas in which “R” is written, refer to renewal areas at various times (“R” is the abbreviation for “renew”). With this conventional renewal method, irrespective of an odd-numbered frame or an even-numbered frame, brightness setting is collectively renewal for all light emitting areas in synchronization with the vertical synchronization signal (“Vsync”), every time scanning for one frame is finished. That is, with this renewal method, renewal is performed in frame sequences without synchronizing with scanning of an image signal. Note that the number of display areas in the vertical direction is generally set less than the number of vertical pixels (i.e. the number of lines) of liquid crystal panel 110. Both numbers seem to be the same as in FIG. 7 to FIG. 9, including FIG. 7A, because these figures are schematic diagrams.

By contrast with this, FIG. 7B shows an example of an renewal method according to the present embodiment. In this case, in the light emitting areas belonging to group A, brightness setting is renewed every odd-numbered frame, and, in the light emitting areas belonging to group B, brightness setting is renewed every even-numbered frame. In each odd-numbered and even-numbered frame, the left part of this figure shows how an image signal is scanned in liquid crystal panel 110, and the right part of this figure shows how brightness setting is renewed in LED backlight 121. The light emitting areas in which “R” is written, refer to renewal areas at various times. The example shown in FIG. 7B and the example of FIG. 7A are the same in renewing brightness setting in synchronization with a vertical synchronization signal (“Vsync”). However, with the example shown in FIG. 7B, the brightness setting of the light emitting areas of group A is renewed collectively every time scanning of an odd-numbered frame is finished, and brightness setting of the light emitting areas of group B is collectively renewed every time scanning of an even-numbered frame is finished.

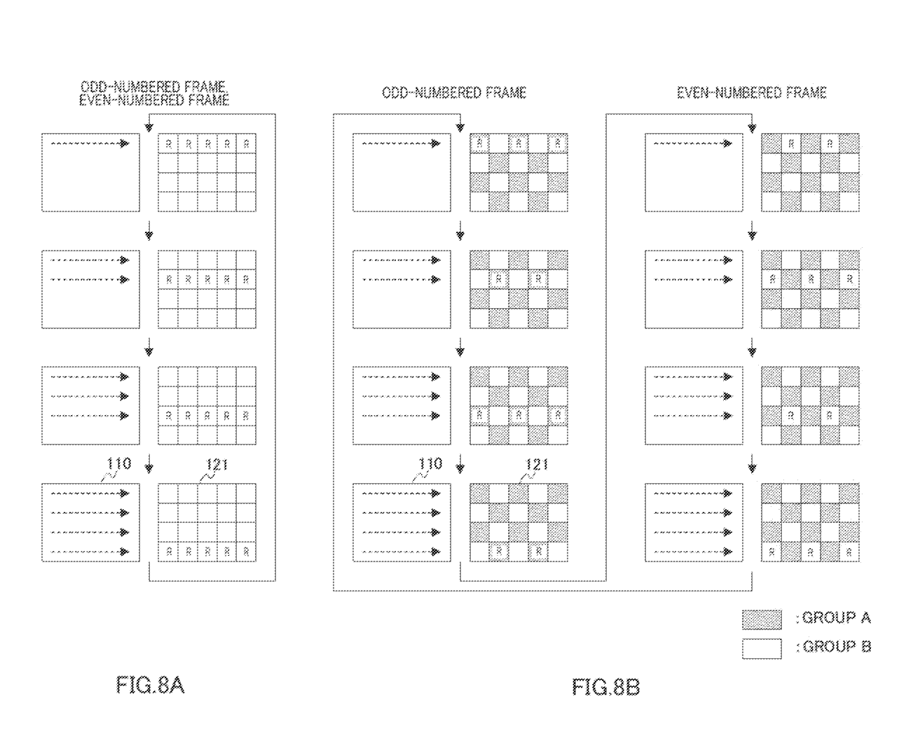

FIG. 8 illustrates another example of a method of renewing brightness setting according to the present embodiment, where FIG. 8A is a schematic diagram showing another example of a conventional renewal method and FIG. 8B is a schematic diagram showing another example of a renewal method according to the present embodiment.

To be more specific, FIG. 8A shows a conventional renewal method for renewing brightness setting in units of the width of one display area, in the vertical direction in synchronization with scanning of an image signal. Note that the left part of this figure shows how an image signal is scanned in liquid crystal panel 110, and the right part of this figure shows how brightness setting is renewed in LED backlight 121. Further, the light emitting areas in which “R” is written, refer to renewal areas at various times. With this conventional renewal method, irrespective of an odd-numbered frame or an even-numbered frame, brightness setting in light emitting areas matching the width of one display area in the vertical direction is collectively renewed, in synchronization with scanning of an image signal, every time pixels matching the width of one display area in the vertical direction are scanned. With this renewal method, renewal is performed in line sequences in the method of FIG. 7A.

By contrast with this, FIG. 8B shows another example of a renewal method according to the present embodiment. Also in this case, similar to FIG. 7B, brightness setting in the light emitting areas belonging to group A is renewed every odd-numbered frame, and brightness setting in the light emitting areas belonging to group B is renewed every odd-numbered frame. Further, in each odd-numbered and even-numbered frame, the left part of this figure shows how an image signal is scanned in liquid crystal panel 110, and the right part of this figure shows how brightness setting is renewed in LED backlight 121. Further, the light emitting areas in which “R” is written, refer to renewal areas at various times. The example shown in FIG. 8B and the example of FIG. 8A are the same in renewing brightness setting in units of the width of one display area, in the vertical direction in synchronization with scanning of an image signal. However, with the example shown in FIG. 8B, for the light emitting areas of group A, brightness setting in light emitting areas matching the width of one display area is collectively renewed every time pixels matching the width of one display area in the vertical direction of an odd-numbered frame are scanned. Then, for the light emitting areas of group B, brightness setting in the light emitting areas matching the width of one display area is collectively renewed every time pixels matching the width of one display area in the vertical direction of an even-numbered frame are scanned.

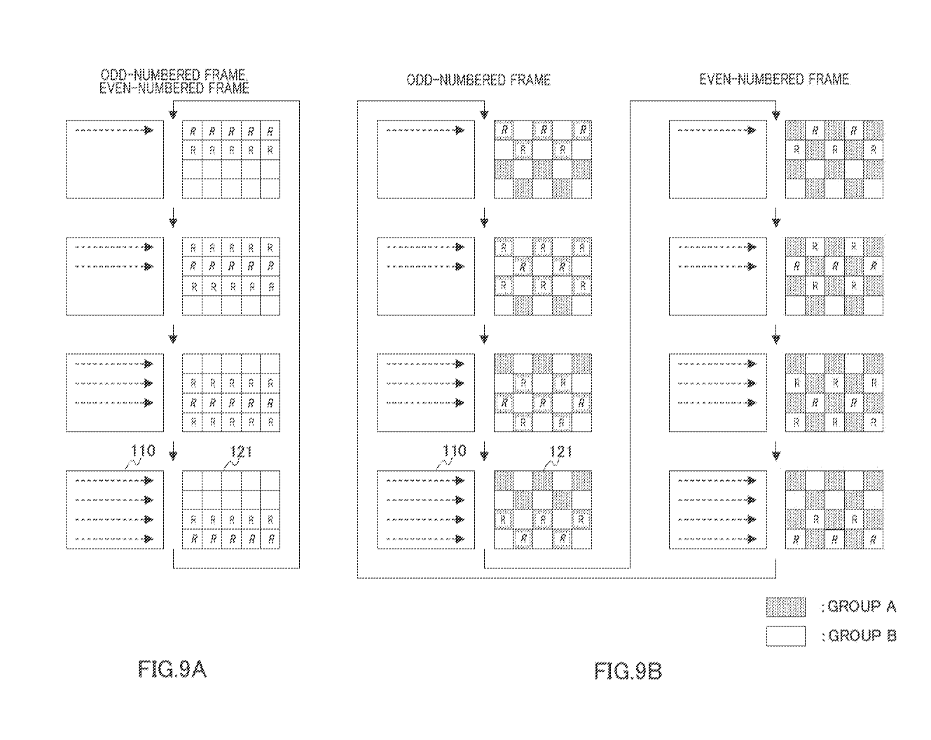

FIG. 9 illustrates another example of a method of renewing brightness setting according to the present embodiment, where FIG. 9A is a schematic diagram showing another possible example of a renewal method and FIG. 9B is a schematic diagram showing another example of a renewal method according to the present embodiment.

To be more specific, FIG. 9A shows another method of renewing brightness setting in synchronization with scanning of an image signal. Note that the left part of this figure shows how an image signal is scanned in liquid crystal panel 110, and the right part of this figure shows how brightness setting is renewed in LED backlight 121. Further, the light emitting areas in which “R” is written, refer to renewal areas at various times. Bold and italic “R” written in the figure refers to renewal in light emitting areas corresponding to a display area in which writing of the latest image signal is finished, in an applicable frame period. This method supports cases where brightness information of a target display area is calculated based on the feature amount of an image signal in the target display area (i.e. each display area) and its surrounding display areas. With this renewal method, irrespective of an odd-numbered frame or an even-numbered frame, brightness setting in light emitting areas matching the width of some display areas in the vertical direction is collectively renewed in synchronization with scanning of an image signal, every time pixels matching the width of one display area in the vertical direction are scanned. That is, this renewal method is one modified example of a case where renewal is performed in line sequences in the vertical direction in synchronization with scanning of an image signal.

By contrast with this, FIG. 9B shows another example of a renewal method according to the present embodiment. Also in this case, similar to FIG. 7B, brightness setting in the light emitting areas belonging to group A is renewed every odd-numbered frame, and brightness setting in the light emitting areas belonging to group B is renewed every odd-numbered frame. Further, in each odd-numbered and even-numbered frame, the left part of this figure shows how an image signal is scanned in liquid crystal panel 110, and the right part of this figure shows how brightness setting is renewed in LED backlight 121. Further, the light emitting areas in which “R” is written, refer to renewal areas at various times. Further, similar to FIG. 9A, bold and italic “R” written in the figure refers to renewing a light emitting area corresponding to a display area in which writing of the latest image signal is finished, in an applicable frame period. The example shown in FIG. 9B and the example of FIG. 9A are the same in renewing brightness setting in synchronization with scanning of an image signal. However, with the example shown in FIG. 9B, for the light emitting areas of group A, the brightness setting in light emitting areas matching the width of some display areas in the vertical direction is collectively renewed every time pixels matching the width of one display area in the vertical direction of an odd-numbered frame are scanned. Then, for the light emitting areas of group B, brightness setting in light emitting areas matching the width of some display areas in the vertical direction is collectively renewed every time pixels matching the width of one display area in the vertical direction of an even-numbered frame are scanned.

On the other hand, there is the following flexibility in the process up to transmission of a brightness setting value. Feature amount detecting section 131 may detect the feature amount of only display areas corresponding to light emitting areas of a group to be renewed, or detect the feature amount of all display areas. Further, brightness calculating section 132 may calculate brightness values of only light emitting areas of a group to be renewed, or may calculate brightness values of all light emitting areas. Further, image signal correcting section 140 can select whether or not to correct an image signal. In either case, while there is a possibility that a more optimized image is acquired if the latter is selected, it is preferable to select the former to reduce the calculation load or the size of the required memory capacity.

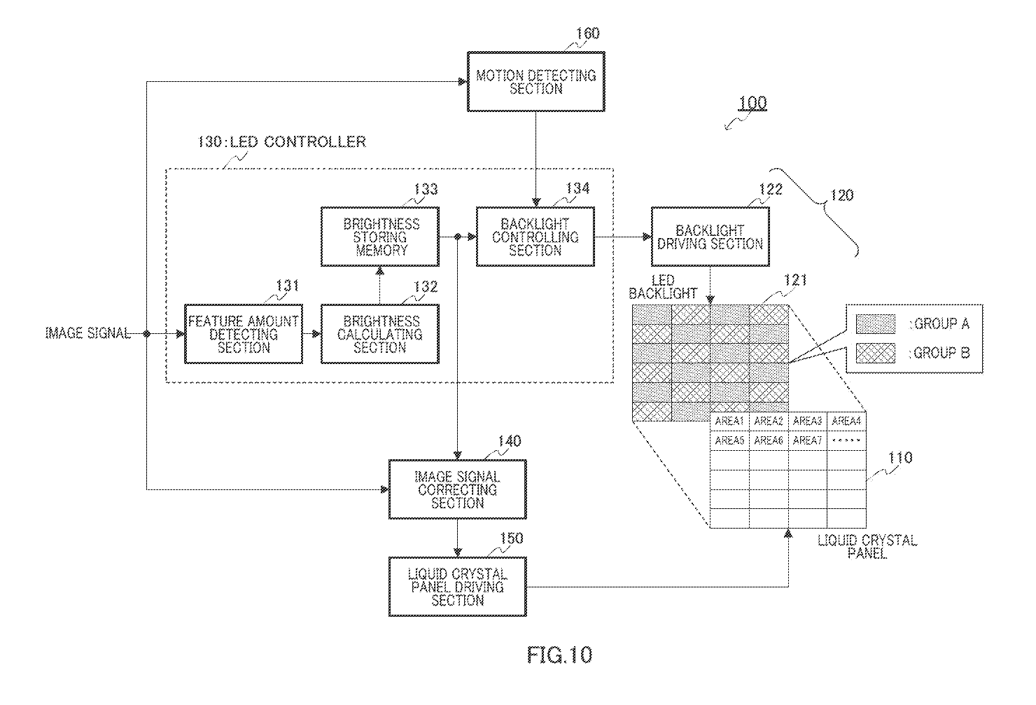

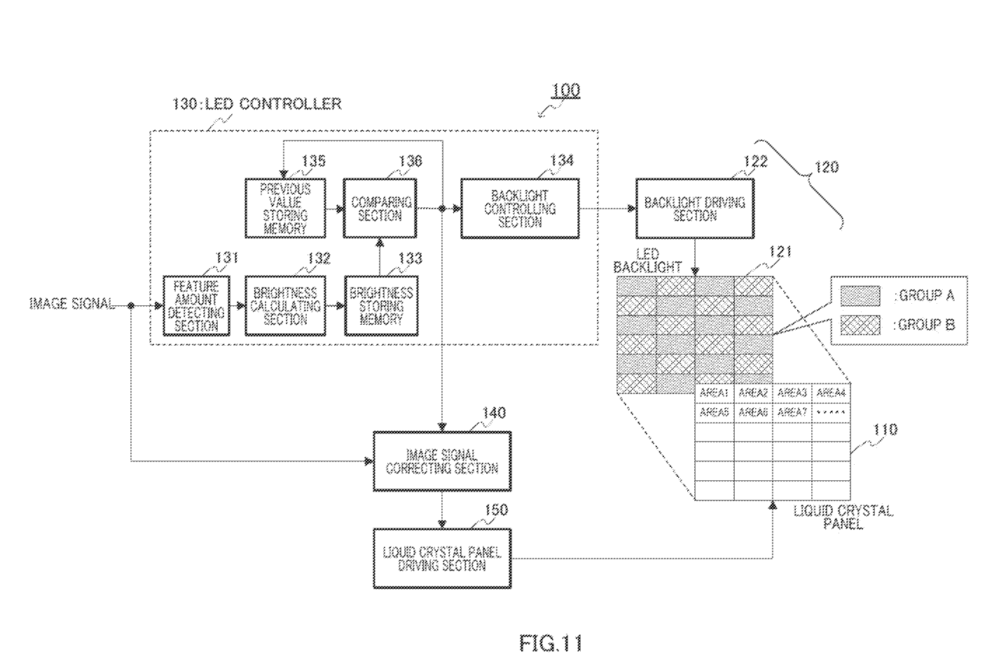

Further, setting is equally possible such that light emitting areas corresponding to specific display areas belong to a plurality of groups. That is, a configuration is possible where at least part of a plurality of light emitting areas simultaneously belong to at least two or more groups of a plurality of groups. For example, grouping of light emitting areas is changed dynamically such that light emitting areas corresponding to display areas in portions in which the motion is decided to be fast by a motion vector analysis of an image, belong to a plurality of groups. FIG. 10 is a block diagram showing a configuration of liquid crystal display apparatus 100 having a component (i.e. motion detecting section 160) for performing this motion vector analysis. By employing this configuration, the frequency to renew brightness setting with respect to portions in which the motion is fast, is increased to optimize contrast. Then, if the motion in the display areas becomes little when, for example, a scene changes, grouping where light emitting areas corresponding to these display areas belong to a plurality of groups, is changed to grouping where light emitting areas corresponding to display areas belong to a single group.

Note that motion detecting section 160 may evaluate the magnitude of the motion of an image in the entire screen instead of performing a motion vector analysis in area units as described above. Further, backlight controlling section 134 changes the light emitting areas belonging to each group according to the evaluation result, that is, according to the magnitude of the motion of an image For example, in case where the motion of an image is little in the entire screen, grouping is performed such that each light emitting area belongs to only one of a plurality of groups, or, in case where the motion of an image is significant, grouping is performed such that all light emitting areas belong to all of a plurality of groups. This means equivalently that, in case where the motion of an image is little, light emitting areas belonging to different groups alternately become subject to renewal of brightness setting (alternate renewal), and, in case where the motion of an image is significant, all light emitting areas always become subject to renewal of brightness (overall renewal). In case where this binary control is adopted, that is, in case where switching is performed between alternate renewal and overall renewal, it is preferable to avoid a negative effect that is likely to be observed upon switching, by using a hysteresis circuit or a time filter in parallel.

Further, as another control example that can realize the same purpose, the number of groups may be changed based on the magnitude of motion while maintaining the period to switch a group constant. For example, the number of groups is made less when motion is more significant, and the number of groups is made greater when motion is less significant. To be more specific, when motion becomes significant, a specific group is combined with another group, or this specific group is divided and combined with a plurality of other groups. Further, when motion becomes less significant, one or more specific groups are each divided into a plurality of groups. Significant motion means that there is a high possibility that the optimal brightness value in each light emitting area changes. Considering that the entire screen is adjusted to light emission brightness that is based on the latest image when the number of groups is less, this control is obviously effective.

Further, as another control example, the period to switch a group may be changed based on the magnitude of motion. For example, when motion is more significant, the period is made shorter (that is, the frequency is made higher), and, when motion is less significant, the period is made longer (that is, the frequency is made lower). Considering that the entire screen is adjusted to light emission brightness that is based on the latest image when the period is made shorter, this control is obviously effective.

Here, depending on the accuracy to calculate the amount of motion, there are cases where the circuit scale increases when a circuit for motion vector analysis is added. However, most of recent television receivers have a circuit section (i.e. frame rate converting section) for converting the frame rate of an image signal, and a motion vector analysis is performed inside this circuit section. Consequently, by taking advantage of vector information from this circuit, it is possible to avoid a significant increase in the circuit scale. Note that the frame rate converting section generates an intermediate frame from an image signal prior to being inputted to liquid crystal panel 110 to convert the vertical scanning frequency of an image signal X times greater (where X is a real number greater than one). Assuming an original image signal of a vertical scanning frequency of 60 Hz, in case where, for example, the conversion rate is double, the vertical scanning frequency of an image signal after conversion processing is 120 Hz. There are cases where the conversion rate is greater than double such as triple or quadruple, or there are cases where the conversion rate is less than double such as 1.5 times. This conversion processing realizes a technique known as “double speed drive,” providing an advantage of smoothing an image and reducing blurs in images.

With some aforementioned control examples, according to an image, particularly, according to the magnitude of a motion in an image calculated by a motion vector analysis, it is possible to suppress the transmission load and unnecessary radiation at requisite minimum while performing quality local contrast control.

Note that it is possible to realize the same advantage without performing a motion vector analysis. FIG. 11 is a block diagram showing a modified example of a configuration of liquid crystal display apparatus 100 for realizing this. With this configuration, LED controller 130 of liquid crystal display apparatus 100 has previous value storing memory 135 in addition to brightness storing memory 133. Further, LED controller 130 further has comparing section 136 that calculates for each light emitting area the difference between the output of brightness storing memory 133 and the output of previous value storing memory 135, and compares the difference with a predetermined threshold. The output of brightness storing memory 133 is the latest light emission brightness value determined per light emitting area by brightness calculating section 132 based on the latest image signal. The output of previous value storing memory 135 is a light emission brightness value showing a present, actual light emitting state of each light emitting area. Only when the difference related to a certain light emitting area exceeds the threshold, comparing section 136 outputs the latest light emission brightness value determined for this light emitting area, together with a write command.

Hereinafter, a control example in liquid crystal display apparatus 100 shown in FIG. 11 will be explained using a case as an example where light emitting areas are divided in two groups A and B and brightness setting is renewed per one frame of an image signal.

Now, assume a phase to renew brightness setting of group A. At this time, light emission brightness values of the light emitting areas belonging to group A are written in brightness storing memory 133. Comparing section 136 sequentially reads light emission brightness of each light emitting area belonging to group A.

On the other hand, in previous value storing memory 135, the light emission brightness value of each light emitting area of group A and the light emission brightness value of each light emitting area of group B upon previous renewal are stored. That is, these are light emission brightness values showing the present, actual light emitting areas in all light emitting areas. Comparing section 136 reads the light emission brightness value of each light emitting area belonging to group A out of these values, sequentially from previous value storing memory 135.

Then, comparing section 136 calculates the difference between values of the same light emitting area read from both of previous value storing memory 135 and brightness storing memory 133, and compares the difference with a threshold. If, as a result of comparison, the difference related to this light emitting area is larger than the threshold, comparing section 136 outputs the value read from brightness storing memory 133 and its write command. If the difference is smaller than the threshold, comparing section 136 does not output anything related to this light emitting area.

In case where there is an output from comparing section 136, backlight controlling section 134 generates a control signal for backlight driving section 122, based on the light emission brightness value of each light emitting area outputted from comparing section 136, and outputs this to backlight driving section 122. Backlight driving section 122 drives LED backlight 121 based on this control signal as described above. Therefore, when the difference related to a certain light emitting area and calculated in comparing section 136 is large, renewal of brightness setting in this light emitting area is executed. On the other hand, when the difference related to a certain light emitting area and calculated from comparing section 136 is small, renewal of brightness setting in this light emitting area is avoided.

Further, in case where there is an output from comparing section 136, the value outputted from comparing section 136, that is, the latest light emission brightness value that is actually adopted, is always stored in previous value storing memory 135.

By this means, it is possible to suppress communication with respect to LED drive ICs at requisite minimum.

Now, assuming that a plurality of LED drive ICs are used, this control shows the greatest effectiveness in case where LED drive ICs corresponding (1) and (3) among classifications (1) to (4) of the above LED drive ICs are used. This is because whether to execute or avoid renewal of brightness can be selected every light emitting area.

Note that this control is also effective in case where other types of LED drive ICs than the above are used.

Even if, for example, LED drive ICs are the type corresponding to (2) and (3), it is possible to select between executing or avoiding renewal of brightness every light emitting area in case where one IC is assigned to one light emitting area. Further, even in case of a configuration of driving LEDs in a plurality of light emitting areas using one IC, the configuration needs to be made as follows. That is, only in case where it is decided that the values of all of a plurality of light emitting areas supported by this IC need not be renewed, communication only needs not be performed with this IC. Although the degree of optimization decreases, the same benefit can be provided.

Further, when the LED drive IC corresponding to (2) and (4) is used, upon renewal of a certain group, communication only needs not be performed only in case where the values of all light emitting areas belonging to a group need not be renewed. By this means, although the degree of optimization decreases, it is possible to provide the same benefit.

Further, this method may be used in parallel with control referred to as “backlight scan.” That is, this method is applicable to control that is known as backlight scan for reducing afterimages by temporarily turning off part of the backlight in synchronization with scanning of an image signal. In this case, sequential turn-off control is performed with respect to only groups to renew (or not to renew) brightness setting in an applicable frame. To be more specific, a period to turn off illuminating section 120 in synchronization with scanning of an image signal is provided such that a group to be turned off is switched per this turn-off period. By so doing, it is possible to suppress the decrease in brightness caused when the backlight is turned off (generally, although brightness in the turn-off period is increased to secure brightness, this increases a load on the light source and power source accordingly).

Here, a case will be explained where sequential turn-off control is performed with respect to groups in which brightness setting is not renewed. Some LED drive ICs can turn on and turn off LEDs according to a method of sequentially turning off LEDs and then turning on LEDs again. For example, an LED drive IC performs control to turn on and turn off LEDs according to a brightness setting command, or a current source on/off command for each channel or all channels transmitted in the same line and with the same transmission scheme as the brightness setting command. This LED drive IC is a drive IC that can be realized by controlling a certain dedicated pin simply to a high level or to a low level. In this case, the transmission line for the current source on/off command is not the same transmission line as for the brightness setting command, so that it is easy to apply sequential turn-off control to a group different from the group in which brightness setting is renewed. Brightness setting is renewed to improve contrast, and sequential turn-off control is performed to improve blurs in movies. By distributing these improvement effects in a plurality of groups, it is possible to display an image such that both contrast and blurs in movies are improved not only in a specific group but also in all groups, while reducing the load for control and transmission.

Further, control for turning off the entire backlight for a certain time per frame to improve blurs in movies is known. Also in this case, similar to the above, LEDs to be turned off may be switched per group. That is, in this case, a period to turn off illuminating section 120 is provided per frame, and a group to be turned off is switched every turn-off period.

Thus, according to the present embodiment, a plurality of light emitting areas are divided into a plurality of groups, and a group to renew the setting of light emission brightness is switched every N frame (where N is a natural number) of an image signal, so that it is possible to perform quality local contrast control while reducing memory capacity, calculation load and transmission load.

Further, when the above backlight scan technique is combined with the present invention, high-quality image display is possible by combining light source control and liquid crystal panel control with little memory capacity, calculation load and transmission load.

Note that in case of a configuration where the light source of LED backlight 121 acquires white light by blending LEDs of three colors of R (red), G (green) and B (Blue), the method of the present invention may be applied to renewal of the blending ratio. It is known that there are three patterns of local contrast control including control of the brightness direction, control of the chromaticity direction and mixed control combining these. As to mixed control in particular, per signal level (also “brightness level of each color”) of each of R, G and B, not per brightness of an image signal, the feature amount is detected, the LED brightness of each color is calculated and the LED brightness of each color is stored. As to correction of images, R components, G components and B components are corrected separately. The flow is completely the same as the outline of control of brightness alone (where an image signal is an RGB signal or color difference signal). As to transmission, even LEDs in the same light emitting area transmit different data per color. Accordingly, in case of mixed control, it is obvious that, generally, the calculation load and the transmission load are heavy compared to the case of control of brightness alone. However, by using the method of the present invention, it is possible to reduce these loads without significantly undermining the quality of display images.

Some modified examples of the configuration and control explained with the present embodiment can be appropriately combined and implemented.

The disclosure of Japanese Patent Application No. 2009-044586, filed on Feb. 26, 2009, including the specification, drawings and abstract, is incorporated herein by reference in its entirety.

### INDUSTRIAL APPLICABILITY

The backlight apparatus according to the present invention provides an advantage of performing quality local contrast control while reducing the transmission load, and is useful as, for example, a backlight of an image display apparatus that requires a light source such as a liquid crystal display. Further, the image display apparatus using this backlight apparatus can be utilized as, for example, a liquid crystal display apparatus such as a liquid crystal television and a liquid crystal monitor.

### REFERENCE SIGNS LIST

100 IMAGE DISPLAY APPARATUS
110 LIQUID CRYSTAL PANEL
120 ILLUMINATING SECTION
121 LED BACKLIGHT
122 BACKLIGHT DRIVING SECTION
123 LED
130 LED CONTROLLER
131 FEATURE AMOUNT DETECTING SECTION
132 BRIGHTNESS CALCULATING SECTION
133 BRIGHTNESS STORING MEMORY
134 BACKLIGHT CONTROLLING SECTION
135 PREVIOUS VALUE STORING MEMORY
136 COMPARING SECTION
140 IMAGE SIGNAL CORRECTING SECTION
150 LIQUID CRYSTAL PANEL DRIVING SECTION
160 MOTION DETECTING SECTION

1. A backlight apparatus comprising:
a light emitting section that comprises P light emitting areas which individually emit illumination light and which are divided into Q groups, where P is an integer equal to or more than two and Q is an integer equal to or more than two and equal to or less than P, and that radiates the illumination light from the P light emitting areas onto a light modulating section;
a feature amount detecting section that detects a feature amount of an image signal;
a determining section that determines light emission brightness values of the P light emitting areas, per light emitting area, based on the detected feature amount; and
a driving section that renews light emitting states in the P light emitting areas per group, based on the determined light emission brightness values, while driving the P light emitting areas,
wherein the driving section switches a group to renew a light emitting state among the Q groups, every N frame of the image signal, where N is a natural number.

2. The backlight apparatus according to claim 1, wherein:
the light modulating section comprises a display surface including P display areas, and displays an image on the display surface by modulating the illumination light radiated from the P light emitting areas according to the image signal;
the P light emitting areas are arranged in positions each corresponding to each of the P display areas to illuminate each of the P display areas; and
the P light emitting areas are divided such that a plurality of light emitting areas belong to each of the Q groups, and are arranged in a uniform distribution over an entirety of the light emitting surface.

3. The backlight apparatus according to claim 2, wherein the P light emitting areas are divided such that a same number of light emitting areas belong to each of the Q groups.

4. The backlight apparatus according to claim 2, wherein the P light emitting areas are divided such that at least part of the P Light emitting areas simultaneously belong to different groups.

5. The backlight apparatus according to claim 2, wherein the P light emitting areas are divided such that the plurality of light emitting areas belonging to each of the Q groups are distributed in a checkered pattern.

6. The backlight apparatus according to claim 2, wherein the P light emitting areas are divided such that the plurality of light emitting areas belonging to each of the Q groups are arranged in one of a vertical stripe pattern, a horizontal stripe pattern and a diagonal stripe pattern.

7. The backlight apparatus according to claim 2, wherein the P light emitting areas are divided such that the plurality of light emitting areas belonging to each of the Q groups are distributed in a concentric pattern.

8. The backlight apparatus according to claim 1, wherein the driving section renews the light emitting state in frame sequences without synchronizing with scanning of the image signal.

9. The backlight apparatus according to claim 1, wherein the driving section renews the light emitting state in line sequences in a vertical direction, in synchronization with scanning of the image signal.

10. The backlight apparatus according to claim 1, wherein the driving section provides a period to turn off the light emitting section per frame period, and switches a group to be turned off.

11. The backlight apparatus according to claim 1, wherein the driving section provides a period to turn off the light emitting section in synchronization with scanning of the image signal, and switches a group to be turned off.

12. The backlight apparatus according to claim 1, wherein the light emitting section uses light emitting diodes as light sources.

13. The backlight apparatus according to claim 1, further comprising a motion detecting section that detects an amount of motion of the image signal,
wherein the driving section dynamically controls a period of the switching based on the detected amount of motion.

14. The backlight apparatus according to claim 4, further comprising a motion detecting section that detects an amount of motion of the image signal,
wherein the driving section dynamically controls light emitting areas simultaneously belonging to different groups, based on the detected amount of motion.

15. The backlight apparatus according to claim 4, further comprising a motion detecting section that detects an amount of motion of the image signal,
wherein the driving section dynamically controls the number of the groups Q based on the detected amount of motion.

16. The backlight apparatus according to claim wherein the driving section executes or avoids renewal of a light emitting state in a specific light emitting area, according to a difference between a light emission brightness value representing a current light emitting state in a specific area and a light emission brightness value newly determined for the specific light emitting area.

17. An image display apparatus comprising:
the backlight apparatus according to claim 1; and
the light modulating section.
